(19) United States
(12) Patent Application Publication
(10) Pub. No.: US 2015/0193267 A1
(43) Pub. Date: Jul. 9, 2015

(54) SYSTEMS AND METHODS FOR A SAVE BACK FEATURE

(71) Applicant: Joel Shafer, Flower Mound, TX (US)

(72) Inventor: Joel Shafer, Flower Mound, TX (US)

(73) Assignee: QUICKOFFICE, INC., Plano, TX (US)

(21) Appl. No.: 13/396,688

(22) Filed: Feb. 15, 2012

(51) Int. Cl. G06F 9/46; G06F 17/30

(52) U.S. Cl. CPC G06F 9/468; G06F 17/30091

(57) ABSTRACT

Systems and methods for a save back feature are provided. In a restricted operating system environment, for example, a first application may be enabled to receive information back from a second application to which original information was sent from the first application.

### BACKGROUND

Certain operating systems, such as the mobile device operating system iOS 5™ from Apple®, Inc. of Cupertino, Calif., are restricted in their functionality for various reasons, such as to reduce security threats. Such operating systems may, for example, allow a first application to pass information (such as a file) to a second application, but may not enable information to be returned to the first application. In the presence of such a restriction, a cloud storage application may be enabled to have a stored file opened for editing by a file editing application, but may not be capable of receiving an edited version of the file back from the editing application for storage. The restriction therefore seriously reduces the usefulness of both the cloud storage application and the file editing application.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a flow diagram of a method according to some embodiments;

FIG. 3 is a flow diagram of a method according to some embodiments;

FIG. 4A, FIG. 4B, and FIG. 4C are diagrams of example interfaces according to some embodiments;

FIG. 5 is a block diagram of an apparatus according to some embodiments; and

FIG. 6A, FIG. 6B, FIG. 6C, and FIG. 6D are perspective diagrams of example data storage devices according to some embodiments.

### DETAILED DESCRIPTION

Embodiments described herein are descriptive of systems, apparatus, methods, and articles of manufacture for providing a “save back” feature in a restricted operating system environment. In some operating system environments, for example, applications are handled as secure containers with limited inter-application communication options, such as to reduce or prevent opportunities for malware to exploit the operating system. A restricted operating system environment may, in some embodiments, provide for unidirectional inter-application communications such as allowing a first application to send information (e.g., a file) to a second application. The restricted operating system environment may also, however, not provide for any return or reverse communications in response to the communication from the first application to the second application. In such environments, application functionality is severely limited—as is the intent of those structuring the restricted operating system environment in such a manner.

Embodiments described herein provide for system, methods, and articles of manufacture for allowing and/or enabling return or bidirectional communications within such restricted operating system environments. Some embodiments, for example, effectively utilize programming elements of both a first application and a second application to circumvent bidirectional inter-application communication restrictions in a restricted operating system environment. In some embodiments, the unidirectional communication methods provided by the operating system are utilized twice, in reverse directions, to emulate bidirectional communication functionality. According to some embodiments, parameters (e.g., annotations and/or data) may be stored in various application and/or operating system dictionaries to enable such a bidirectional communication work-around.

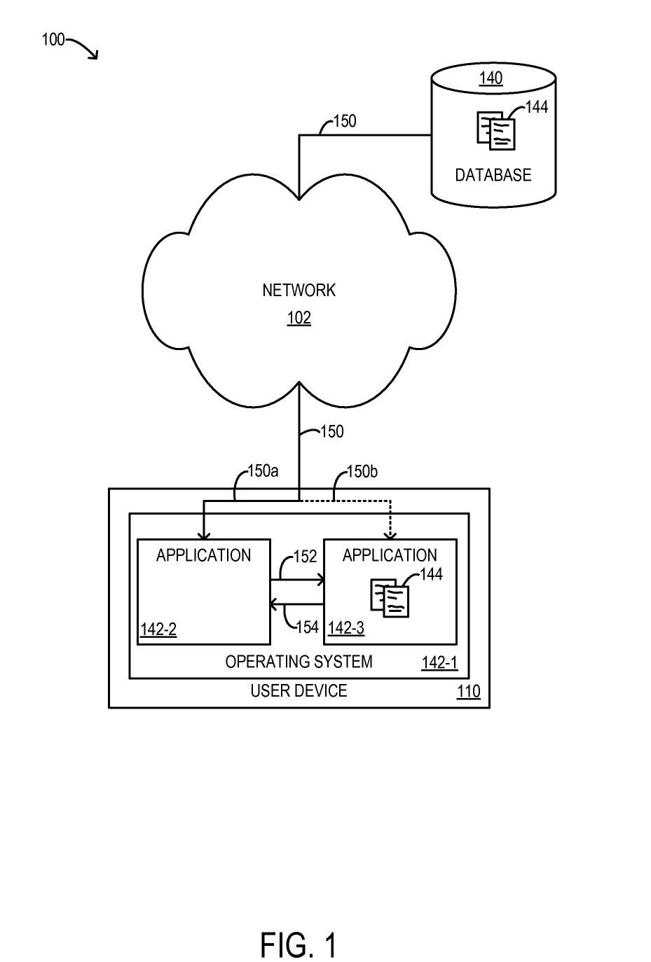

Referring first to FIG. 1, a block diagram of a system 100 according to some embodiments is shown. In some embodiments, the system 100 may comprise a network 102 in communication with (and/or providing for and/or facilitating communications between) a user device 110 and a database 140. In some embodiments, the database 140 may be remote from the user device 110—e.g., the database 140 may comprise a “cloud” storage device. According to some embodiments, the user device 110 may store, execute, and/or be otherwise associated with an operating system 142-1 and/or one or more applications 142-2, 142-3. In some embodiments, the database 140 may store and/or the operating system 142-1 and/or one or more of the applications 142-2, 142-3 may utilize a file 144.

The network 102 may, according to some embodiments, comprise a Local Area Network (LAN; wireless and/or wired), Wide Area Network (WAN; wireless and/or wired), cellular telephone network, Bluetooth® network, Near-Field Communication (NFC) network, and/or Radio Frequency (RF) network with communication links between the user device 110 and the database 140. In some embodiments, the network 102 may comprise direct communications links between any or all of the components 110, 140 of the system 100. The user device 110 may, for example, be directly interfaced or connected to the database 140 via one or more wires, cables, wireless links, and/or other network components, such network components (e.g., communication links) comprising portions of the network 102. In some embodiments, the network 102 may comprise one or many other links or network components other than those depicted in FIG. 1. The user device 110 may, for example, be connected to the database 140 via various cell towers, routers, repeaters, ports, switches, and/or other network components that comprise the Internet and/or a cellular telephone (and/or Public Switched Telephone Network (PSTN)) network, and which comprise portions of the network 102.

While the network 102 is depicted in FIG. 1 as a single object, the network 102 may comprise any number, type, and/or configuration of networks that is or becomes known or practicable. According to some embodiments, the network 102 may comprise a conglomeration of different sub-networks and/or network components interconnected, directly or indirectly, by the components 110, 140 of the system 100. The network 102 may comprise one or more cellular telephone networks with communication links between the user device 110 and the database 140, for example, and/or may comprise the Internet, with communication links between the user device 110 and the database 140, for example.

The user device 110, in some embodiments, may comprise any type or configuration of computing, mobile electronic, network, user, and/or communication device that is or become known or practicable. The user device 110 may, for example, comprise one or more PC devices, computer workstations (e.g., underwriter workstations), tablet computers, such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, such as in the case that the user device 110 comprises an iPad® or similar tablet computing device, the operating system 142-1 may comprise a restricted operating system environment such as Apple® iOS 4 or 5. In such embodiments, the applications 142-2, 142-3 may be developed utilizing a Software Development Kit (SDK) such as the Apple® SDK 3.2 (not explicitly shown in FIG. 1). In some embodiments, the user device 110 (and/or the database 140) may store and/or execute specially programmed instructions to operate in accordance with embodiments described herein. In some embodiments, the operating system 142-1 and/or the applications 142-2, 142-3 may comprise such stored and/or specially programmed instructions. According to some embodiments, the user device 110 (and/or the database 140) may comprise a computerized processing device such configured and/or coupled to provide a save back feature (e.g., in accordance with embodiments described herein).

In one example of how the system 100 may be utilized, the first application 142-2 may comprise a cloud storage application that manages and/or facilitates storage of the file 144 in the database 140. The first application 142-2 may be utilized, for example, to retrieve (and/or provide) the file 144 via a first communication and/or path 150. In some embodiments, such as in the case that the first application 142-2 is utilized to download the file 144 to the user device 110, the first communication and/or path 150 may direct the file 144 to the first application 142-2, the operating system 142-1, and/or to the user device 110 generally, via a first path option 150a. In some embodiments, the first communication and/or path 150 and/or the first path option 150a may be utilized to upload the file 144 to the database 140 (e.g., the reverse of the example direction shown in FIG. 1). According to some embodiments, such as in the case that the first application 142-2 is utilized to open the file 144 in the second application 142-3 (e.g., via a first command path 152), the file 144 may be sent from the database 140 via a second path option 150b of the first communication and/or path 150, directly (and/or via the operating system 142-1) to the second application 142-3.

The first command path 152 may comprise, for example, an “OpenIn” communication from the first application 142-2 to the operating system 142-1, which causes the file 144 to be opened in the second application 142-3. The second application 142-3 may, for example, comprise a file editing program such as QuickOffice® available from QuickOffice, Inc. of Plano, Tex. The file 144 may be opened in the second application 142-3, for example, to allow, permit, and/or enable editing of the file 144 (e.g., a functionality that the first application 142-2 may be lacking, in accordance with some embodiments). In some embodiments, the providing of the file 144 to the second application 142-3 via the second path option 150b of the first communication and/or path 150 and/or via the first command path 152 may comprise providing data descriptive of the file 144, data defining the file 144, and/or data associated with the file 144 and/or the first application 142-2. According to some embodiments, for example, the file 144 and annotations (e.g., supplemental data associated with the file 144 and/or the first application 142-2) may be provided to the second application 142-3.

According to some embodiments, the second application 142-3 may be utilized to view, access, edit, encrypt, and/or otherwise act upon the file 144. In some embodiments, the file 144 (e.g., as edited and/or otherwise acted upon) may be provided back to the first application 142-2 via the second command path 154. In some embodiments, the return of the file 144 and/or annotations via the second command path 154 may comprise an action not provided for (and/or typically prevented) by the operating system 142-1. In the case that the operating system 142-1 only provides functionality (e.g., via an SDK utilized to program the functionality of the first and/or second applications 142-2, 142-3) for the ability to transfer data (e.g., the file 144) in a unidirectional manner, such as via the first command path 152, the operating system 142-1, the first application 142-2, and/or the second application 142-3 may be modified and/or configured as described herein to provide for the return communication and/or transfer of data (e.g., the file 144). In such a manner, for example, the file 144 may be saved back to the first application 142-2 and/or the database 140 (e.g., via the first application 142-2 and/or via the operating system 142-1)—e.g., a “save back” feature.

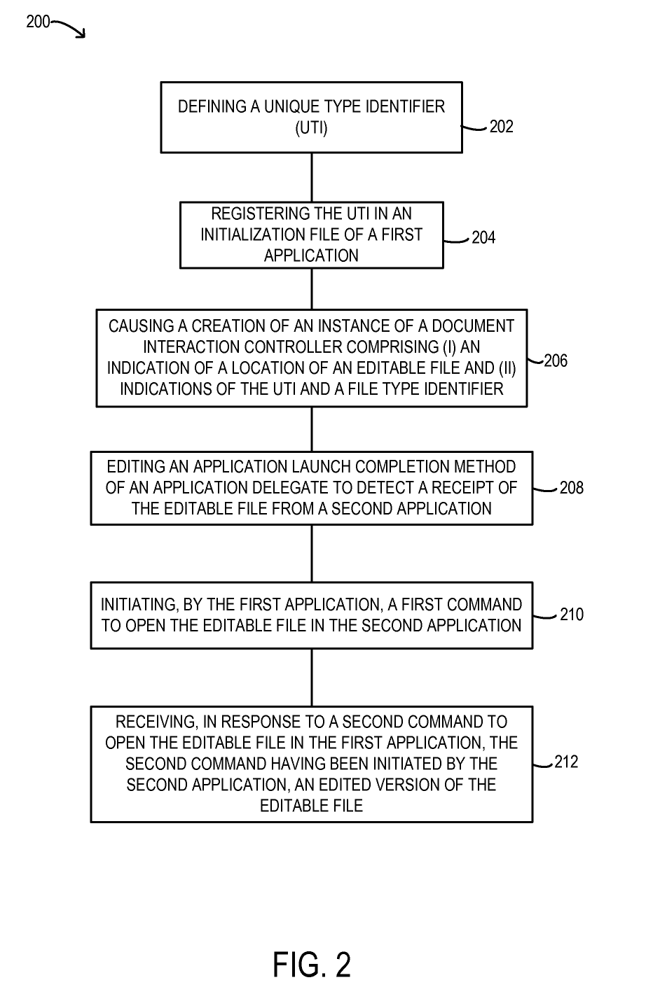

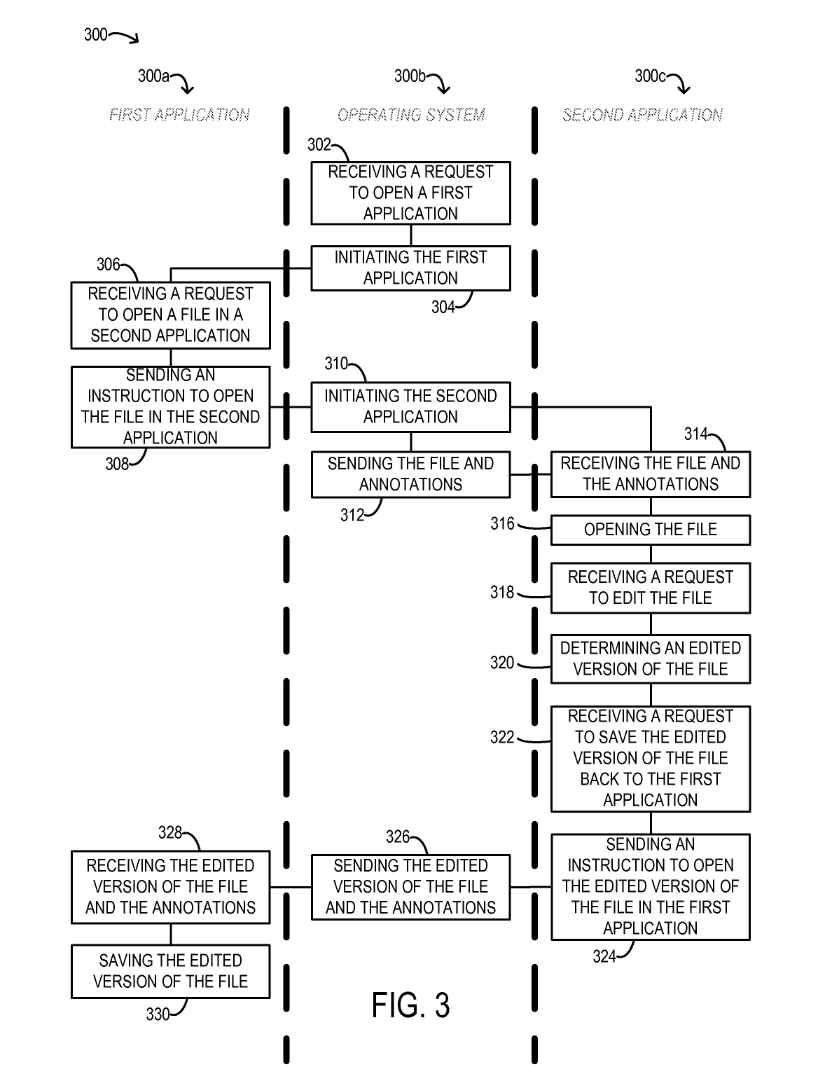

Fewer or more components 102, 110, 140, 142-1, 142-2, 142-3, 144, 150, 150a-b, 152, 154 and/or various configurations of the depicted components 102, 110, 140, 142-1, 142-2, 142-3, 144, 150, 150a-b, 152, 154 may be included in the system 100 without deviating from the scope of embodiments described herein. In some embodiments, the components 102, 110, 140, 142-1, 142-2, 142-3, 144, 150, 150a-b, 152, 154 may be similar in configuration and/or functionality to similarly named and/or numbered components as described herein. In some embodiments, the system 100 (and/or portion thereof, such as the user device 110) may be programmed to and/or may otherwise be configured to execute, conduct, and/or facilitate any or all of the methods 200, 300, 300a-c of FIG. 2 and/or FIG. 3 and/or portions or combinations thereof described herein.

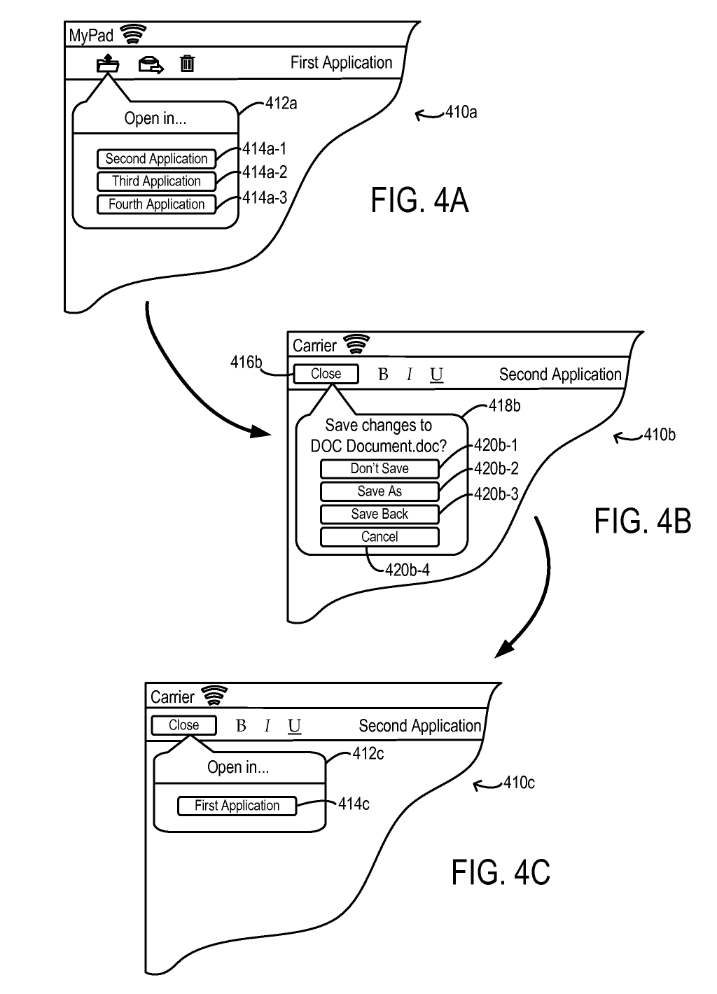

Turning to FIG. 2, a flow diagram of a method 200 according to some embodiments is shown. In some embodiments, the method 200 may be performed and/or implemented by and/or otherwise associated with one or more specialized and/or computerized processing devices, specialized computers, computer terminals, computer servers, computer systems and/or networks, and/or any combinations thereof (e.g., the user device 110 of FIG. 1). In some embodiments, the method 200 may be embodied in, facilitated by, and/or otherwise associated with various input mechanisms and/or interfaces such as the example interfaces 410a-c described with respect to FIG. 4 herein. In some embodiments, the components 202, 204, 206, 208, 210, 212 of the method 200 may be similar in configuration and/or functionality to similarly named and/or numbered components as described herein.

The process and/or flow diagrams described herein do not necessarily imply a fixed order to any depicted actions, steps, and/or procedures, and embodiments may generally be performed in any order that is practicable unless otherwise and specifically noted. Any of the processes and/or methods described herein may be performed and/or facilitated by hardware, software (including microcode), firmware, or any combination thereof. For example, a storage medium (e.g., a hard disk, Universal Serial Bus (USB) mass storage device, and/or Digital Video Disk (DVD)) may store thereon instructions that when executed by a machine (such as a computerized processing device) result in performance according to any one or more of the embodiments described herein.

In some embodiments, the method 200 may be illustrative of a process implemented to provide a save back feature for applications operating in a restricted operating system environment. In some embodiments, the method 200 may be implemented by, as part of, and/or otherwise in association with a first application such as a cloud storage application as described for exemplary purposes herein. According to some embodiments, the method 200 may comprise defining a Unique Type Identifier (UTI), at 202. The UTI may, for example, comprise data representing a first application. According to some embodiments, the UTI may comprise a reverse domain name identifier and/or an indication of a unique file extension. The reverse domain name identifier may, for example, comprise an address associated with the first application (e.g., “com.service.cloud”). The unique file extension, in some embodiments, may comprise a non-typical and/or non-standard file extension designation and/or an Internet media type and/or Multi-purpose Internet Mail Extension (MIME) type. Standard and/or typical file extensions may comprise Microsoft® Word™ document extensions (“.doc” and/or “.docx”), Microsoft® Excel document extensions (“.xls” and/or “.xlsx”), Adobe® Acrobat™ portable document format extensions (“.pdf”), and/or other file extensions and/or types that are known and utilized. In some embodiments, the unique file extension may comprise a file extension and/or type not recognized by standard and/or typical software programs. In some embodiments, the unique file extension may be specifically defined and/or chosen to not be identifiable to known software applications (e.g., “.csc”).

In some embodiments, the method 200 may comprise registering the UTI in an initialization file of the first application, at 204. Registering the UTI with an operating system by adding the UTI information to the initialization file, for example, may allow and/or enable the first application to be associated with the unique file extension. In some embodiments, as a result of the registering, the first application may appear as a menu option (or the only menu option) when attempting to open, save, and/or otherwise utilize files with the unique file extension. In some embodiments, such as in the case that the initialization file comprises an “info.plist” file, the registering may comprise editing the initialization file as follows:

```
<key>CFBundleDocumentTypes</key>
      <array>
            <dict>
                  <key>CFBundleTypeExtensions</key>
                  <array>
                        <string>csc</string>
                  </array>
                  <key>CFBundleTypeName</key>
                  <string>Cloud File Manager</string>
                  <key>CFBundleTypeRole</key>
                  <string>Editor</string>
                  <key>LSItemContentTypes</key>
                  <array>
                        <string>com.service.cloud</string>
                  </array>
                  <key>LSTypeIsPackage</key>
                  <false/>
                  <key>NSDocumentClass</key>
                  <string>Document</string>
                  <key>NSPersistentStoreTypeKey</key>
                  <string>Binary</string>
            </dict>
      </array>
      <key>UTExportedTypeDeclarations</key>
      <array>
            <dict>
                  <key>UTTypeDescription</key>
                  <string>Cloud File Manager</string>
                  <key>UTTypeIdentifier</key>
                  <string>com.service.cloud</string>
                  <key>UTTypeTagSpecification</key>
            <dict>
                  <key>com.service.cloud</key>
                  <string>csc</string>
                  <key>public.filename-extension</key>
                  <array>
                        <string>csc</string>
                  </array>
            </dict>
      </dict>
</array>
```

where “csc” comprises an indication of the example unique file extension, “Cloud File Manager” comprises an indication of an example name of a first application, and “com.service.cloud” comprises an indication of the UTI for the first application.

In some embodiments, the UTI may be defined to comprise the unique file extension (e.g., “com.quickoffice.docinteraction.qpa”; where “docinteraction” is the first application and “qpa” is the unique file extension) and/or a MIME-type may also or alternatively be utilized. In such embodiments, the registering may comprise editing the initialization file as follows:

| | | |
|---|---|---|
| URL Types | Array | (0 items) |
| Bundle Version | String | 3.0.0 |
| Application requires iPhone environment | Boolean | YES |
| Main nib file base name | String | MainWindow |
| Main nib file base name (iPad) | String | MainWindow-iPad |
| Application supports iTunes file sharing | Boolean | YES |
| Supported interface orientations | Array | (4 items) |
| Exported Type UTIs | Array | (1 item) |
| Item 0 | Dictionary | (3 items) |
| Description | String | QuickOffice Partner |
| Identifier | String | com.quickoffice.docinteraction.qpa |
| Equivalent Types | Dictionary | (2 items) |
| public.filename-extension | String | qpa |
| public.mime-type | String | application/docinteraction |
| Imported Type UTIs | Array | (0 items) |

where “qpa” comprises an indication of the example unique file extension, “application/docinteraction” comprises an indication of an associated MIME-type, “docinteraction” comprises an indication of an example name of a first application, and “com.quickoffice.docinteraction.qpa” comprises an indication of the UTI for the first application (which also, in this example, comprises the unique file extension).

According to some embodiments, the method 200 may comprise causing a creation of an instance of a document interaction controller comprising (i) an indication of a location of an editable file, and (ii) indications of the UTI and a file type identifier, at 206. A document interaction controller such as the “UIDocumentInteractionController” of iOS™ may, for example, be edited to include annotations such as the file location, the UTI, and/or a file type identifier such as the unique file extension and/or MIME-type associated with the first application. In some embodiments, the annotations may be provided to the document interaction controller as dictionary elements, such as follows:

NSMutableDictionary*dict=[NSMutableDictionary dictionaryWithCapacity:3];
//REQUIRED
[dict setObject:[NSString stringWithFormat:©“com.service.cloud”] forKey:©“UTI”];
[dict setObject:[NSString stringWithFormat:©“csc”] forKey:©“extension”];
//OPTIONAL ADDITIONAL DATA
[dict setObject:[path lastPathComponent] forKey:©“filename”]; // The first application will use this to know what the original filename is when it gets the file back.
self.docController.annotation=dict.

According to some embodiments, various types and/or quantities of annotations may be provided to the second application via the document interaction controller dictionary. A secret identifier or key such as a secret Universally Unique Identifier (UUID) may be provided (e.g., a “PartnerApplicationSecretKey” variable), for example, to show the second application that the first application is authorized to utilize a save back feature as described herein. In such a manner, for example, only authorized application partners (e.g., first applications that are registered as partners to the second application) may be able to utilize the save back feature via the second application. In some embodiments, an “AppIdentifier” of the first application may be provided (e.g., a “PartnerApplicationIdentifierKey” variable), the UTI may be provided (e.g., as a “PartnerApplicationDocumentUTIKey” variable), the unique file extension (and/or the “real” document extension (e.g., “.docx”); such as in the case that the UTI already comprises an indication of the unique file extension) may be provided (e.g., as a “PartnerApplicationDocumentExtensionKey” variable), and/or other data such as an original document filename may be provided via the annotations of the document interaction controller.

In some embodiments, the method 200 may comprise editing an application launch completion method of an application delegate to detect a receipt of the editable file from the second application, at 208. In the case of iOS™, for example, the “didFinishLaunchingWithOptions” method may be defined and/or edited as follows:

```
(BOOL)application:(UIApplication *)application
didFinishLaunchingWithOptions:(NSDictionary *)launchOptions {
        [self applicationDidFinishLaunching:application];
        //Override point for customization after application launch.
        NSURL *url = (NSURL *)[launchOptions
objectForKey:UIApplicationLaunchOptionsURLKey];
        if(url && [url isFileURL])
        {
                //Save the FileName
                self.mFileName =[[url path] lastPathComponent];
                viewController.mLabel.text = mFileName;
                //Save any extra data that the calling application passed
so that we can pass it back
                self.mAnnotations = (NSDictionary *)[launchOptions
objectForKey:UIApplicationLaunchOptionsAnnotationKey];
//Open the file as normal now
```

In such a manner, for example, when receiving a file from the second application, the first application knows where to look to determine desired annotation information descriptive of the file (e.g., as “saved back” file). In some embodiments, the defining at 202, the registering at 204, the causing of the creation at 206, and/or the editing at 208 may be conducted and/or effectuated during coding of the first application. The defining at 202, the registering at 204, the causing of the creation at 206, and/or the editing at 208 may, for example, be conducted via a processing device to enable a first application to cooperate with a second application to provide a save back feature as described herein.

According to some embodiments, the method 200 may comprise initiating (e.g., by the first application) a first command to open the editable file in the second application, at 210. The first application may, for example, receive a request to initiate and/or otherwise initiate an “OpenIn” command to cause an opening of a file in the second application. In some embodiments, the execution of the first command may provide the editable file, the UTI, a secret key, an application identifier of the first application, a file path of the file, and/or an original filename to the second application. Any or all such data may be provided, for example, as described with respect to the defining at 202, the registering at 204, the causing of the creation at 206, and/or the editing at 208. In some embodiments, such as in the case that the “OpenIn” functionality does not provide for or permit information to be returned from the second application in response thereto, the annotations provided via the operating system (as described with respect to the method 200 and/or otherwise as described herein) may allow and/or enable the second application (e.g., if properly setup) to perform a second “OpenIn” command (in the reverse), effectively returning the file and pertinent data back to the first application.

In some embodiments, the method 200 may comprise receiving (e.g., in response to a second command to open the editable file in the first application, the second command having been initiated by the second application) an edited version of the editable file, at 212. Annotation information descriptive of and/or associated with the file may also be received and/or provided (e.g., via the operating system, such as via the “didFinishLaunchingWithOptions” method) and an indication of the original filename. The first application may utilize the file and associated information to save the file back to an original (and/or other specified and/or desirable) location—e.g., on a cloud storage device such as the database 140 of FIG. 1. In the case of iOS™, for example, the “didFinishLaunchingWithOptions” method may be defined and/or edited as follows:

```
- (BOOL)application:(UIApplication *)application didFinishLaunchingWithOptions:(NSDictionary
*)launchOptions {
        [self applicationDidFinishLaunching:application];
        //THIS IS UTILIZED BY THE SECOND APPLICATION TO PASS A FILE BACK TO
THE FIRST APPLICATION TO STORE IN THE CLOUD
        NSURL *url = (NSURL *)[launchOptions
objectForKey:UIApplicationLaunchOptionsURLKey];
        if(url && [url isFileURL])
        {
                //ANNOTATIONS PASSED BACK TO THE FIRST APPLICATION. Use if
needed to figure out *where* the file belongs in the cloud for example
                self.mAnnotations = (NSDictionary*)[launchOptions
objectForKey:UIApplicationLaunchOptionsAnnotationKey];
        //Access the data from the returned file
                NSError * err=nil;
                NSString * data =[NSString stringWithContentsOfURL:url
encoding:NSUTF8StringEncoding error:&err];
                //Get the original filename - if originally stored in the annotations
        NSString * filename = [self.mAnnotations objectForKey:@“filename”].
```

Turning to FIG. 3, a flow diagram of a method 300 according to some embodiments is shown. In some embodiments, the method 300 may be performed and/or implemented by and/or otherwise associated with one or more specialized and/or computerized processing devices, specialized computers, computer terminals, computer servers, computer systems and/or networks, and/or any combinations thereof (e.g., the user device 110 of FIG. 1). According to some embodiments, the method 300 may comprise various portions and/or sub-methods 300a-c, each sub-method being performed, in some embodiments, by a different device and/or as a result of execution of different stored instructions. In some embodiments, a first sub-method 300a may be performed by and/or as a result of execution of a first application, a second sub-method 300b may be performed by and/or as a result of execution of an operating system, and/or a third sub-method 300c may be performed by and/or as a result of execution of a second application. In some embodiments, the method 300 (and/or one or more of the sub-methods 300a-c, such as the first sub-method 300a) may be related to and/or compromise the method 200 of FIG. 2 herein. In some embodiments, the method 300 (and/or one or more of the sub-methods 300a-c) may be embodied in, facilitated by, and/or otherwise associated with various input mechanisms and/or interfaces such as the example interfaces 410a-c described with respect to FIG. 4 herein. In some embodiments, the components 302, 204, 306, 308, 310, 312, 314, 316, 318, 320, 322, 324, 326, 328, 330 of the method 300 may be similar in configuration and/or functionality to similarly named and/or numbered components as described herein.

In some embodiments, the method 300 (and/or second sub-method 300b) may comprise receiving a request to open a first application (e.g., the first application 142-2 of FIG. 1), at 302. The operating system (e.g., the operating system 142-1 of FIG. 1) may, for example, receive a request form a user of a device upon which the operating system is installed (e.g., the user device 110 of FIG. 1) to open and/or initiate the first application such as by receiving a signal via an input mechanism. According to some embodiments, the method 300 (and/or second sub-method 300b) may comprise initiating the first application, at 304. The operating system may, in response to the receiving at 302 for example, cause the first application to initiate. The first application may initiate and a user may utilize the first application as desired and as is or becomes known or practicable. In some embodiments, such as in the on-going (and non-limiting) example provided herein, the first application may comprise a cloud-storage application such as Dropbox® or Alfresco™.

In some embodiments, the method 300 (and/or first sub-method 300a) may comprise receiving a request to open a file in a second application (e.g., a first request), at 306. The first application may receive via a user interface (e.g., the first example interface 410a of FIG. 4), for example, a request or command for a specific file to “Open in . . . ” a second application. In some embodiments, the second application (e.g., the second application 142-3 of FIG. 1) may comprise a partner application such as a file editing application like QuickOffice®. In some embodiments, it may be desirable to open the file in the second application to realize functionality not available in the first application (e.g., file and/or document editing).

According to some embodiments, the method 300 (and/or first sub-method 300a) may comprise sending an instruction to open the file in the second application (e.g., a first instruction), at 308. In response to the receiving of the first request at 306, for example, the first application may send an “OpenIn” command (and/or other appropriate command) to the operating system. In some embodiments, the sending at 308 may comprise sending or providing certain information such as a file path of the file, an original filename of the file, contents of the file, and/or an actual file extension (e.g., “.xls”) of the file.

In some embodiments, the method 300 (and/or second sub-method 300b) may comprise initiating the second application, at 310. In response to the sending of the first instruction at 308, for example, the operating system may cause the second application to be opened and/or initiated (e.g., in the case that the second application is not already open). In some embodiments, focus may be transferred to the second application. In the case that the second application is already open and/or initiated, only the focus may be transferred to the second application at 310 (e.g., the opening may not be required). According to some embodiments, the method 300 (and/or second sub-method 300b) may comprise sending the file and annotations, at 312. The operating system may, for example, provide any necessary data from the first application that may be utilized by the second application to receive and/or open the file (such as the file path, file name, and/or file contents). The sending of the file and the annotations may, in some embodiments, comprise merely providing the file and/or annotations to the second application. In some embodiments, the sending and/or providing may comprise sending certain data to the second application (e.g., the file path) and providing other data to the second application (e.g., providing access to other data such as the original file name, UTI of the first application, unique file type identifier, secret key or code, etc.).

In some embodiments, the method 300 (and/or third sub-method 300c) may comprise receiving the file and the annotations, at 314. In response to the sending (and/pr providing) at 312, for example, the second application may receive and/or access the file information and/or associated annotations. According to some embodiments, the method 300 (and/or third sub-method 300c) may comprise opening the file, at 316. In the case that the second application is provided with the file path and/or name of the file (e.g., at 312 and/or 314), for example, the second application may activate and/or open the file (e.g., satisfying and/or completing the first instruction and/or first “OpenIn” command).

In some embodiments, the method 300 (and/or third sub-method 300c) may comprise receiving a request to edit the file, at 318. The second application, in the case that it comprises a file editing application for example, may receive a request from a user (e.g., via a user interface) to edit the file. In some embodiments, such as in the case that the first application and the second application are executed on the same device (e.g., the user device 110 of FIG. 1) the request may be received by the same interface (e.g., a touch screen of an Apple® iPad™) via which the requests at 302 and/or 306 were received.

According to some embodiments, the method 300 (and/or third sub-method 300c) may comprise determining an edited version of the file, at 320. The second application may, in response to the request to edit received at 318 for example, cause the file to be edited. In some embodiments, the method 300 (and/or third sub-method 300c) may comprise receiving a request to save the edited version of the file back to the first application (e.g., a second request), at 322. The second application may receive via a user interface (e.g., the second example interface 410b of FIG. 4), for example, a request or command for a specific file (e.g., the edited version of the file) to “Save Back” to a second application. In the case that the first application comprises a cloud-storage application, for example, the second application may be utilized to edit the file and the user may desire the file to be saved back to a cloud location (e.g., an original location from whence the file originated and/or another specified and/or desired location in the cloud).

According to some embodiments, the method 300 (and/or third sub-method 300c) may comprise sending an instruction to open the edited version of the file in the first application (e.g., a second instruction), at 324. In response to the receiving of the second request at 322, for example, the second application may send an “OpenIn” command (and/or other appropriate command) to the operating system. In some embodiments, the sending at 324 may comprise sending or providing certain information such as a file path of the file, an original filename of the file, and/or contents of the file.

In some embodiments, the method 300 (and/or second sub-method 300b) may comprise sending the edited version of the file and the annotations, at 326. The operating system may, for example, provide any necessary data from the second application that may be utilized by the first application to receive and/or open the file (such as the file path, file name, and/or file contents). According to some embodiments, the method 300 (and/or first sub-method 300a) may comprise receiving the edited version of the file and the annotations, at 328. The first application may, for example, effectively receive back an edited version of the same file for which the first instruction was sent to “OpenIn” the second application—in contravention of (and/or despite) the security mechanisms of the restricted operating system environment. In other words, the cooperative-setup of the first and second applications as partner applications, allows the applications to both realize increased power and flexibility that would otherwise not be possible in the restricted operating system environment.

In some embodiments, the method 300 (and/or first sub-method 300a) may comprise saving the edited version of the file, at 330. The first application may complete the save back functionality by causing the edited version of the file to be saved back (e.g., to an original location) to a data storage device. In such a manner, for example, the first application may take full advantage of the capabilities of the second application, despite operating in a restricted environment.

Turning now to FIG. 4A, FIG. 4B, and FIG. 4C, diagrams of example interfaces 410a-c according to some embodiments are shown. In some embodiments, the interfaces 410a-c may comprise web pages, web forms, database entry forms, API screens, spreadsheets, tables, and/or application or other GUI screens via which a user may effectuate a save back feature in a restricted operating environment. The interfaces 410a-c may, for example, comprise screens of mobile device applications programmed and/or otherwise configured to execute, conduct, and/or facilitate any of the various methods 200, 300 of FIG. 2 and/or FIG. 3 and/or portions, sub-methods 300a-c, and/or combinations thereof described herein. In some embodiments, the interfaces 410a-c may be output via a computerized device such as the user device 110 of FIG. 1 herein. Components of the interfaces 410a-c may be similar in configuration and/or functionality to any similarly-named and/or numbered components described herein.

According to some embodiments, a first interface 410a may comprise an interface of a first application (such as the first application 142-2 of FIG. 1). The first interface 410a may, for example, comprise an “Open in . . . ” menu 412a activated by a user of a mobile device (such as the user device 110 of FIG. 1). In some embodiments, the “Open in . . . ” menu 412a may present one or more options such as one or more other external applications 414a via which a selected and/or desired file may be opened (e.g., utilizing the “OpenIn” functionality of iOS™). The user may choose, in the example of FIG. 4A for example, whether to open the desired file utilizing a “Second Application” 414a-1, a “Third Application” 414a-2, and/or a “Fourth Application” 414a-3. Solely for sake of example and coordination of terminology utilized herein, assume that the user has selected (and the first application has accordingly received an indication of the selection of) the “Second Application” 414a-1 via which to open the desired file in. In some embodiments, the receiving of the request via the user selection of the “Second Application” 414a-1 may comprise the “first request” of 306 of the method 300. According to some embodiments, a second application may be initiated and/or switched to as a result of the receiving of the first request. The first application may, as described herein for example, initiate an “OpenIn” command in response to the request, causing the operating system to activate the selected second application.

In some embodiments, the second application may be utilized to open the desired document as described herein. According to some embodiments, when the user is done editing and/or otherwise utilizing the file or document via the second application, the user may activate, via a second interface 410b of the second application, a “Close” button 416b. The “Close” button 416b may, for example, provide a “Save changes” menu 418b providing a variety of save options 420b. The user may choose, for example, not to save the edited file (e.g., a “Don't Save” option 420b-1), to save the edited file as a particular file name and in a particular location (e.g., a “Save As” option 420b-2), to save the edited file back to the first application and/or a location associated therewith (e.g., a “Save Back” option 420b-3), and/or to cancel the save operation (e.g., a “Cancel” option 420b-4). In the case that the user desires to save the edited file back to the first application (and/or save the edited file utilizing the first application), the user may select (and the second application may receive an indication of the selection of) the “Save Back” option 420b-3. In some embodiments, the receiving of the request via the user selection of the “Save Back” option 420b-3 may comprise the “second request” of 322 of the method 300 (and/or a portion thereof).

According to some embodiments, selection of the “Save Back” option 420b-3 may cause a third interface 410c to be displayed via the second application. The third interface 410c may comprise, for example, an “Open in . . . ” menu 412c (e.g., a “reverse” “OpenIn” back to the first application). In some embodiments, the “Open in . . . ” menu 412c may only present a single option 414c (e.g., the “First Application” option 414c). For example, due to (i) the registration of the first application's UTI and/or unique file type/extension with the operating system and (ii) the passing of the UTI and/or an indication of the unique file type/extension with the file as annotations (e.g., dictionary elements) to the second application, in accordance with some embodiments, the first application may be the only available (e.g., registered) option for opening files of the unique type/extension (e.g., “.csc” and/or “.qpa”) and the “Open in . . . ” menu 412c may accordingly only show the “First Application” option 414c. In some embodiments, although not explicitly shown in the depiction of the third interface 410c, the “First Application” option 414c may only be provided in the case that a code and/or key of the first application is verified. In other words, in some embodiments, only registered partner applications of the second application may have the save back functionality enabled via the second application. In some embodiments, a receiving of a request via the user selection of the “First Application” option 414c may comprise the “second request” of 322 of the method 300 (and/or a portion thereof).

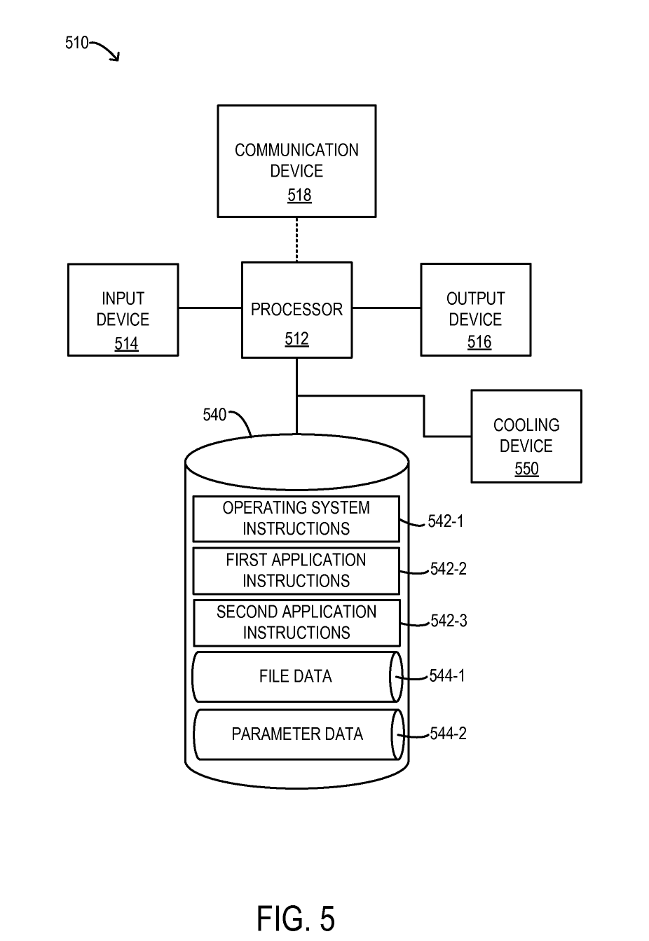

Turning to FIG. 5, a block diagram of an apparatus 500 according to some embodiments is shown. In some embodiments, the apparatus 500 may be similar in configuration and/or functionality to the user device 110 of FIG. 1 herein. The apparatus 500 may, for example, execute, process, facilitate, and/or otherwise be associated with the methods 200, 300 of FIG. 2 and/or FIG. 3 herein, and/or may output or provide various interfaces such as the interfaces 410a-c of FIG. 4 herein. In some embodiments, the apparatus 500 may comprise an electronic processor 512, an input device 514, an output device 516, a communication device 518, and/or a memory device 540. Fewer or more components 512, 514, 516, 518, 540 and/or various configurations of the components 512, 514, 516, 518, 540 may be included in the apparatus 500 without deviating from the scope of embodiments described herein. In some embodiments, the components 512, 514, 516, 518, 540 of the apparatus 500 may be similar in configuration and/or functionality to similarly named and/or numbered components as described herein.

According to some embodiments, the electronic processor 512 may be or include any type, quantity, and/or configuration of electronic and/or computerized processor that is or becomes known. The electronic processor 512 may comprise, for example, an Intel® IXP 2800 network processor or an Intel® XEON™ Processor coupled with an Intel® E7501 chipset. In some embodiments, the electronic processor 512 may comprise multiple inter-connected processors, microprocessors, and/or micro-engines. According to some embodiments, the electronic processor 512 (and/or the apparatus 500 and/or other components thereof) may be supplied power via a power supply (not shown) such as a battery, an Alternating Current (AC) source, a Direct Current (DC) source, an AC/DC adapter, solar cells, and/or an inertial generator. In some embodiments, such as in the case that the apparatus 500 comprises a server such as a blade server, necessary power may be supplied via a standard AC outlet, power strip, surge protector, and/or Uninterruptible Power Supply (UPS) device.

In some embodiments, the input device 514 and/or the output device 516 are communicatively coupled to the electronic processor 512 (e.g., via wired and/or wireless connections, traces, and/or pathways) and they may generally comprise any types or configurations of input and output components and/or devices that are or become known, respectively. The input device 514 may comprise, for example, a keyboard (physical and/or virtual) that allows an operator of the apparatus 500 to interface with the apparatus 500 (e.g., a user desiring to activate a document editing program as a shell from within a cloud storage program). The output device 516 may, according to some embodiments, comprise a display screen and/or other practicable output component and/or device. The output device 516 may, for example, provide document data (e.g., via a website and/or via a mobile device platform). According to some embodiments, the input device 514 and/or the output device 516 may comprise and/or be embodied in a single device such as a touch-screen tablet and/or smart phone display.

In some embodiments, the communication device 518 may comprise any type or configuration of communication device that is or becomes known or practicable. The communication device 518 may, for example, comprise a Network Interface Card (NIC), a telephonic device, a cellular network device, a router, a hub, a modem, and/or a communications port or cable. In some embodiments, the communication device 518 may be coupled to receive and/or transmit document information internally within a device between different applications and/or externally to and/or from a remote data storage device in accordance with embodiments described herein. According to some embodiments, the communication device 518 may also or alternatively be coupled to the electronic processor 512. In some embodiments, the communication device 518 may comprise an Infra-red Radiation (IR), RF, Bluetooth™, NFC, and/or Wi-Fi® network device coupled to facilitate communications between the electronic processor 512 and one or more other devices (such as a remote data storage device).

The memory device 540 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM). The memory device 540 may, according to some embodiments, store one or more of operating system instructions 542-1, first application instructions 542-2, and/or second application instructions 542-3. In some embodiments, the operating system instructions 542-1, first application instructions 542-2, and/or second application instructions 542-3 may be utilized by the electronic processor 512 to provide output information via the output device 516 and/or the communication device 518 (e.g., the opening of the file at 316 of the method 300 (and/or third sub-method 300c) of FIG. 3).

According to some embodiments, the operating system instructions 542-1 may be operable to cause the electronic processor 512 to access file data 544-1 and/or parameter data 544-2 (e.g., in accordance with the second sub-method 300b of FIG. 3 herein). File data 544-1 and/or parameter data 544-2 received via the input device 514 and/or the communication device 518 may, for example, be analyzed, sorted, filtered, decoded, decompressed, ranked, scored, plotted, and/or otherwise processed by the electronic processor 512 in accordance with the operating system instructions 542-1. In some embodiments, file data 544-1 and/or parameter data 544-2 may be fed by the electronic processor 512 through one or more mathematical and/or statistical formulas, rule sets, policies, and/or models in accordance with the operating system instructions 542-1 to facilitate implementation of a save back feature as described herein. In some embodiments, the operating system instructions 542-1 may comprise instructions defining an operating system, platform, and/or environment, such as a restricted mobile device operating system environment—e.g., iOS 5™.

According to some embodiments, the first application instructions 542-2 may be operable to cause the electronic processor 512 to access the file data 544-1 and/or parameter data 544-2 (e.g., in accordance with the first sub-method 300a of FIG. 3 herein). File data 544-1 and/or parameter data 544-2 received via the input device 514 and/or the communication device 518 may, for example, be analyzed, sorted, filtered, decoded, decompressed, ranked, scored, plotted, and/or otherwise processed by the electronic processor 512 in accordance with the first application instructions 542-2. In some embodiments, File data 544-1 and/or parameter data 544-2 may be fed by the electronic processor 512 through one or more mathematical and/or statistical formulas, rule sets, policies, and/or models in accordance with the first application instructions 542-2 to facilitate implementation of a save back feature as described herein. In some embodiments, the first application instructions 542-2 (and/or the operating system instructions 542-1) and/or portions thereof may be configured and/or adapted to facilitate and/or provide a save back feature as described herein (e.g., via the method 200 of FIG. 2 and/or portions thereof).

According to some embodiments, the second application instructions 542-3 may be operable to cause the electronic processor 512 to access the file data 544-1 and/or parameter data 544-2 (e.g., in accordance with the third sub-method 300c of FIG. 3 herein). File data 544-1 and/or parameter data 544-2 received via the input device 514 and/or the communication device 518 may, for example, be analyzed, sorted, filtered, decoded, decompressed, ranked, scored, plotted, and/or otherwise processed by the electronic processor 512 in accordance with the second application instructions 542-3. In some embodiments, File data 544-1 and/or parameter data 544-2 may be fed by the electronic processor 512 through one or more mathematical and/or statistical formulas, rule sets, policies, and/or models in accordance with the second application instructions 542-3 to facilitate implementation of a save back feature as described herein. In some embodiments, the second application instructions 542-3 (and/or the operating system instructions 542-1) and/or portions thereof may be configured and/or adapted to facilitate and/or provide a save back feature as described herein (e.g., via the method 200 of FIG. 2 and/or portions thereof).

In some embodiments, the file data 544-1 may comprise data including, but not limited to, data descriptive of one or more files such as files editable by execution of the second application instructions 542-2. The file data 544-1 may include, for example, file location data, filename data (e.g., an original filename), and/or actual file type and/or extension data. According to some embodiments, the parameter data 544-2 may comprise data including, but not limited to, data descriptive of annotations related to a file. The parameter data 544-2 may include, for example, UTI data, application name data (e.g., of a first application), unique file type and/or extension data, original file name data, actual file type and/or extension data, and/or secret code and/or partner application data.

In some embodiments, the apparatus 500 may comprise a cooling device 550. According to some embodiments, the cooling device 550 may be coupled (physically, thermally, and/or electrically) to the electronic processor 512 and/or to the memory device 540. The cooling device 550 may, for example, comprise a fan, heat sink, heat pipe, radiator, cold plate, and/or other cooling component or device or combinations thereof, configured to remove heat from portions or components of the apparatus 500.

According to some embodiments, the apparatus 500 may generally function as a mobile computing device, for example, which is utilized to execute partnered applications (e.g., defined by the first application instructions 542-2 and the second application instructions 542-3) to provide a save back feature in a restricted operating system environment. In some embodiments, the apparatus 500 may comprise and/or provide an interface via which users may execute the save back functionality (e.g., the interfaces 410a-c of FIG. 4).

Any or all of the exemplary instructions and data types described herein and other practicable types of data may be stored in any number, type, and/or configuration of memory devices that are or become known. The memory device 540 may, for example, comprise one or more data tables or files, databases, table spaces, registers, and/or other storage structures. In some embodiments, multiple databases and/or storage structures (and/or multiple memory devices 540) may be utilized to store information associated with the apparatus 500. According to some embodiments, the memory device 540 may be incorporated into and/or otherwise coupled to the apparatus 500 (e.g., as shown) or may simply be accessible to the apparatus 500 (e.g., externally located and/or situated—such as a cloud storage device). In some embodiments, fewer or more data elements 544-1, 544-2 and/or types than those depicted may be necessary and/or desired to implement embodiments described herein.

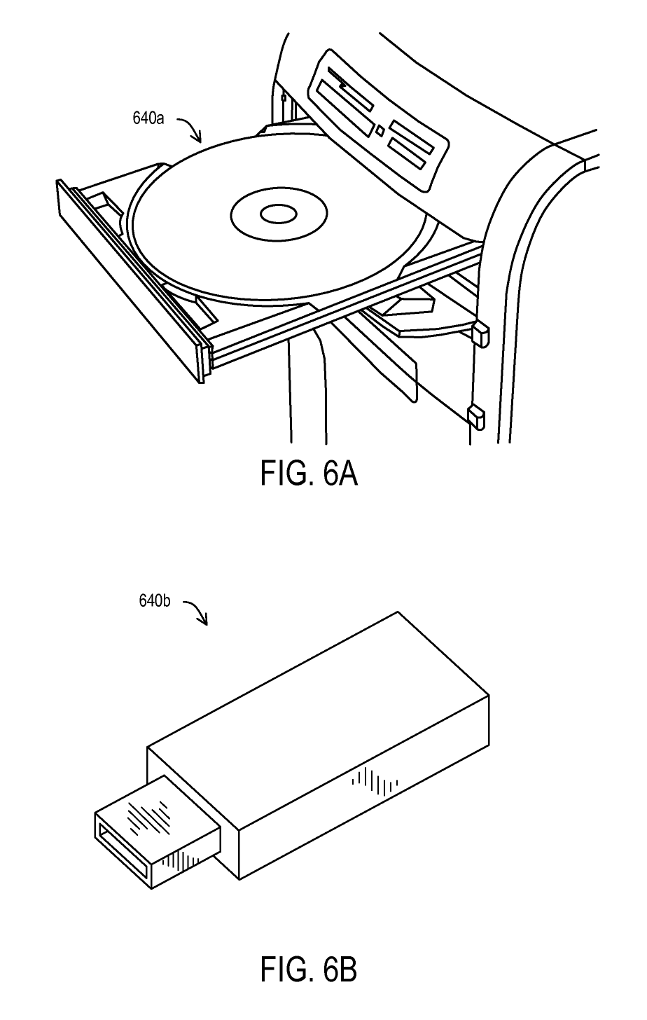

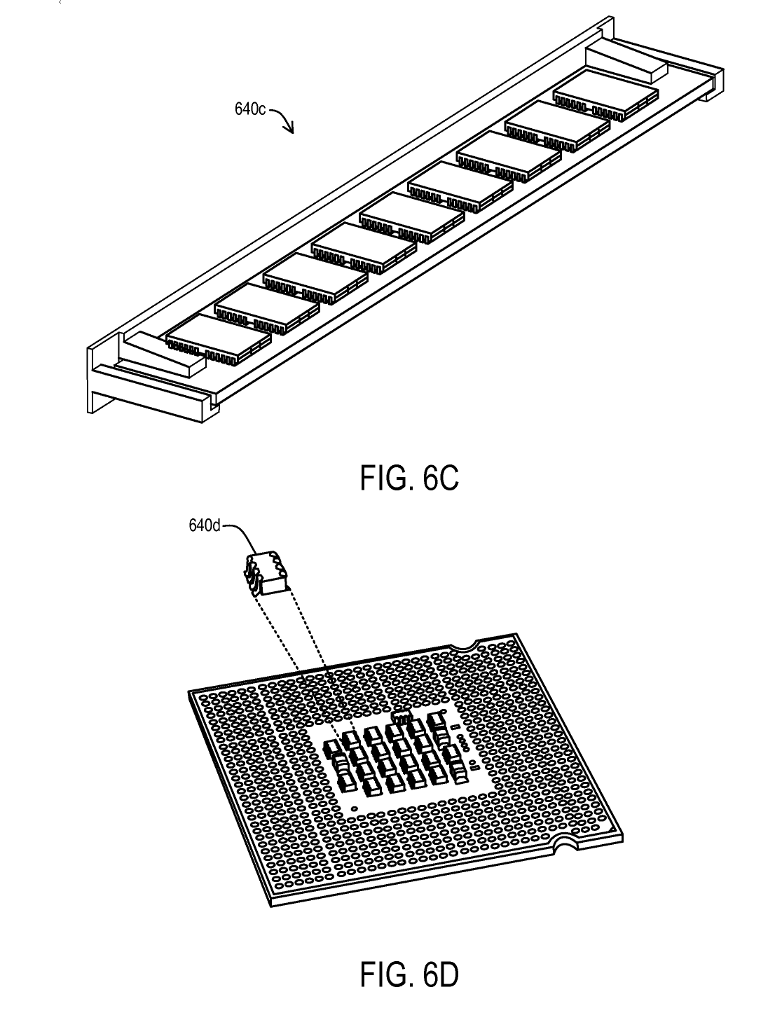

Referring now to FIG. 6A, FIG. 6B, FIG. 6C, and FIG. 6D, perspective diagrams of exemplary data storage devices 640a-d according to some embodiments are shown. The data storage devices 640a-d may, for example, be utilized to store instructions and/or data such as the file data 544-1 and/or parameter data 544-2, each of which is described in reference to FIG. 5 herein. In some embodiments, instructions stored on the data storage devices 640a-d may, when executed by a processor (such as the electronic processor 512 of FIG. 5), cause the implementation of and/or facilitate the methods 200, 300 of FIG. 2 and/or FIG. 3 (and/or portions and/or sub-methods 300a-c thereof), described herein.

According to some embodiments, the first data storage device 640a may comprise a CD, CD-ROM, DVD, Blu-Ray™ Disc, and/or other type of optically-encoded disk and/or other computer-readable storage medium that is or becomes know or practicable. In some embodiments, the second data storage device 640b may comprise a USB keyfob, dongle, and/or other type of flash memory data storage device that is or becomes know or practicable. According to some embodiments, the third data storage device 640c may comprise RAM of any type, quantity, and/or configuration that is or becomes practicable and/or desirable. In some embodiments, the third data storage device 640c may comprise an off-chip cache such as a Level 2 (L2) or Level 3 (L3) cache memory device. According to some embodiments, the fourth data storage device 640d may comprise an on-chip memory device such as a Level 1 (L1) cache memory device.

The data storage devices 640a-d may generally store program instructions, code, and/or modules that, when executed by an electronic and/or computerized processing device cause a particular machine to function in accordance with embodiments described herein. In some embodiments, the data storage devices 640a-d depicted in FIG. 6A, FIG. 6B, FIG. 6C, and FIG. 6D are representative of a class and/or subset of computer-readable media that are defined herein as “computer-readable memory” (e.g., memory devices as opposed to transmission devices). While computer-readable media may include transitory media types, as utilized herein, the term computer-readable memory is limited to non-transitory computer-readable media.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. The right is hereby expressly reserved to file additional applications to pursue patents for subject matter that has been disclosed and enabled but not claimed in the present application.

1. A method of utilizing a processing device to establish a save back feature for applications operating in a restricted operating system environment, comprising:
defining, by the processing device, a Unique Type Identifier (UTI) comprising an indication of a reverse domain name identifier and an indication of a unique file extension;
registering, by the processing device, the UTI in an initialization file of a first application;
causing, by the processing device, a creation of an instance of a document interaction controller comprising (i) an indication of a location of an editable file, and (ii) indications of the UTI and the unique file extension; and
defining, by the processing device, an application launch completion method of an application delegate to detect a receipt of the editable file from a second application.

2. The method of claim 1, further comprising:
initiating, by the first application, a first command to open the editable file in a second application, wherein execution of the first command provides the editable file, the UTI, and an original filename to the second application; and
receiving, in response to a second command to open the editable file in the first application, the second command having been initiated by the second application, an edited version of the editable file and an indication of the original filename.

3. The method of claim 1, wherein the initialization file comprises an ‘info.plist’ file for the application.

4. The method of claim 1, wherein the document interaction controller comprises a ‘UIDocumentInteractionController’ class.

5. The method of claim 1, wherein the document interaction controller further stores an indication of an encoded code.

6. The method of claim 5, wherein the encoded code comprises a cryptographic key.

7. The method of claim 1, wherein the creating of the instance of the document interaction controller comprises:
defining the UTI and the unique file extension as dictionary elements.

8. The method of claim 7, wherein the dictionary elements comprise at least one of ‘NSDictionary’ class elements and NSMutableDictionary′ class elements.

9. The method of claim 1, wherein the application delegate comprises an ‘AppDelegate’ application delegate and wherein the application launch completion method comprises a ‘didFinishLaunchingWithOptions’ method.

10. The method of claim 1, wherein the restricted operating system environment comprises an environment that allows applications to pass files to other applications in only one direction.

11. A method of editing a file in a restricted operating system environment, comprising:
receiving, by a first application in which file editing is not enabled, a request to open an editable file in a second application in which file editing is enabled;
sending, by the first application, in response to the receiving of the request to open and via an operating system, the editable file and an original file name of the file to the second application, wherein the sending comprises providing, to the second application, an indication of a Unique Type Identifier (UTI) and a unique file extension assigned to the first application; and
receiving, by the first application after the sending and via the operating system, and from the second application, the editable file and an indication of the original filename of the editable file.

12. The method of claim 11, further comprising:
saving, by the first application, the received editable file to a cloud storage device.

13. The method of claim 11, wherein the received editable file comprises an edited version of the editable file.

14. The method of claim 11, wherein the restricted operating system environment comprises an environment that allows applications to pass files to other applications in only one direction.

15. The method of claim 11, further comprising:
receiving, by the first application after the sending and via the operating system, and from the second application, an indication of an original file path of the editable file.

16. The method of claim 15, wherein the original file path comprises a restricted-access storage location, further comprising:
receiving, by the first application after the sending and via the operating system, and from the second application, an indication of login credentials for the restricted-access storage location.

17. A mobile device comprising:
a processing device; and
a memory device storing instructions defining (i) an operating system, (ii) a first application, and (ii) a second application, the memory device being in communication with the processing device and
wherein the instructions, when executed by the processing device, result in:
initializing, by the operating system, the first application;
receiving, by the first application, a first request to open a document in the second application;
sending, by the first application, a first instruction to the operating system to open the document in the second application;
initiating, by the operating system, the second application;
sending, by the operating system, to the second application, and in response to the first instruction, the document, an original filename of the document, and a Unique Type Identifier (UTI) of the first application;
opening, by the second application, the document;
receiving, by the second application, an indication of a desired edit to the document;
determining, by the second application and based on the indication of the desired edit, an edited version of the document;
receiving, by the second application, a second request to save the edited version of the document back to the first application;
sending, by the first application, a second instruction to the operating system to open the edited version of the document in the first application;
sending, by the operating system, to the first application, and in response to the second instruction, the edited version of the document and the original filename of the document; and
saving, by the first application, the edited version of the document.

18. The mobile device of claim 17, wherein the first application comprises a cloud storage application and wherein the second application comprises a document editing application.

19. The mobile device of claim 17, wherein the sending, by the operating system, to the second application, and in response to the first instruction, further comprises sending an encoded code.

20. The mobile device of claim 19, wherein the instructions, when executed by the processing device, further result in:
verifying, by the second application, the encoded code; and
opening, by the second application and in response to the verifying, the document.
